(19) United States
(12) Patent Application Publication
(10) Pub. No.: US 2005/0238860 A1
(43) Pub. Date: Oct. 27, 2005

(54) Electrophotographic transfer paper and image forming method

(75) Inventors: Ryosuke Nakanishi, Ebina-shi (JP); Eizou Kurihara, Ebina-shi (JP); Tsukasa Matsuda, Ebina-shi (JP)

Correspondence Address: OLIFF & BERRIDGE, PLC, P.O. BOX 19928, ALEXANDRIA, VA, 22320, US

(73) Assignee: FUJI XEROX CO., LTD., Tokyo (JP)

(21) Appl. No.: 11/008,626

(22) Filed: Dec. 10, 2004

(30) Foreign Application Priority Data
Apr. 26, 2004 (JP) 2004-129988

(51) Int. Cl. G03G 15/16

(52) U.S. Cl. 428/211.1

(57) ABSTRACT

An electrophotographic transfer paper, in which at least one surface of a base material containing pulp fiber has an image receiving surface comprising a coated layer containing pigment and adhesive and a basis weight according to JIS P-8124 is 40 g/m² to 100 g/m², is characterized in that when bending stiffness in a cross direction is defined as A mN·m, smoothness is defined as B sec and volume resistivity is defined as C Ωcm, A, B and C satisfy the following equation after seasoning the electrophotographic transfer paper in each of an environments of 10° C. and 15% RH and 23° C. and 50% RH:
1.0×10−2≦A/(logB×logC)≦3.0×10⁻², and an image forming method using the electrophotographic transfer paper as a toner image receiving body.

### CROSS-REFERENCE TO RELATED APPLICATION

This application claims priority under 35 USC 119 from Japanese Patent Application No. 2004-129988, the disclosure of which is incorporated by reference herein.

### BACKGROUND OF THE INVENTION

1. Field of the Invention

The present invention relates to an electrophotographic transfer paper having a coated layer, which is used for a copying machine and a printer for forming images using an indirect dry type electrophotographic system, and to an image forming method using the electrophotographic transfer paper. The invention particularly relates to a lightweight electrophotographic transfer paper and the image forming method using the electrophotographic transfer paper.

2. Description of the Related Art

In recent years, in the field of on-demand publications, publications which have been conventionally produced using commercial offset printing highly tend to be produced using color copying machines and color printers because these machines can achieve convenient printing and copying of a small number of copies. For this reason, the speed and the image quality of the color copying machines and the color printers are being improved.

In order to improve the image quality, coated paper, which has a high glossiness and is conventionally used in the field of commercial printing, is being increasingly used for the color copying machines and the color printers instead of PPC paper and printer paper which are normally used because the coated paper provides clear images.

The demand is being increased for more lightweight coated paper with a suitable glossiness to be used particularly in text paper of catalogs and booklets, fliers, and leaflets, which require on-demand property.

When the lightweight coated paper having a suitable glossiness which is used in the field of the commercial printing is used in full-color copying machines or printers, however, defective run occurs in a transfer section. Defective run is a phenomenon such that just after paper is charged in the transfer section and toner is transferred to the paper, the paper is stuck to a transfer member in a paper transport direction. Defective run prominently occurs on coated paper with a small basis weight, namely, so-called lightweight coated paper.

An incidence rate of defective run greatly varies according to an installation environment of the full-color copying machine or the printer. Concretely, the full-color copying machine or the printer is generally installed in a fixed position all year round. However, even if paper passes through the transfer section in summer without problems, defective run occasionally occurs in winter in the transfer section of the full-color copying machine or the printer. Further, there is paper for which defective run tends to occur in summer, paper for which defective run tends to occur in winter, paper for which defective run tends to occur at times of comparatively mild weather, such as spring and fall, and the like.

Furthermore, the circumstances of occurrence of defective run vary according to the state of the paper. For example, defective run may occur on paper which has just been taken out of the package in summer, but if this same paper is allowed to stand for a while, it runs without problems. As in this case, the situation of occurrence of defective run varies according to the installation environment of the machine and the state of seasoning of the paper even in the same combination of the full-color copying machine or printer and the paper. Particularly in the field of on-demand printing, defective run becomes a very serious problem.

Japanese Patent Application Laid-Open No. 2002-341581 proposes a method of using different resins on a front side and a rear side of a coated layer or using different coating amounts on the front and rear sides so as to set a Gurley stiffness ratio of the front and rear sides to 0.5 to 1.5 as a method of improving adsorptivity to the transfer member. Depending on a paper feed surface, however, the adsorptive power to the transfer member becomes too strong, whereby defective run occurs in the transfer section.

Japanese Patent Application Laid-Open No. 2000-172001 proposes electrophotographic transfer paper in order to improve irregular charging in a low-humidity environment, and defective images and running property in a high-humidity environment. The electrophotographic transfer paper is such that a center line average roughness (Ra) of a surface of the coated paper whose basis weight is 60 to 100 g/m² is not more than 1.5 μm, volume resistivity is not less than 1×10⁹ Ωcm at 30° C. and 80% RH, and stiffness of the paper is not less than 16 cm. In this method, however, defective run in the transfer section is not improved, and particularly when paper which is subjected to moisture adjustment for a low-temperature/low-humidity environment or paper which is subjected to moisture adjustment in a 23° C. and 50% RH environment is allowed to travel in a low-temperature/low-humidity environment, defective run conspicuously occurs in the transfer section.

Accordingly, a lightweight electrophotographic transfer paper having a coated layer, which is used in full-color copying machines and printers adopting the indirect dry electrophotographic system and which has high gloss in blank portion thereof and superior reliability with respect to excellent running property in various use environments, and particularly with respect to excellent running property in a transfer section, has yet to be provided.

### SUMMARY OF THE INVENTION

The present invention has been made in view of the above circumstances and provides an electrophotographic transfer paper which is lightweight and whose running property in a transfer section in various environments is improved without deteriorating the density of images to be formed, and an image forming method using the paper.

The present invention includes the following configurations.

(1) An electrophotographic transfer paper, in which at least one surface of a base material containing pulp fiber has an image receiving surface comprising a coated layer containing pigment and adhesive and a basis weight according to JIS P-8124, the disclosure of which is incorporated herein by reference, is 40 g/m² to 100 g/m², wherein when bending stiffness in a cross direction is defined as A mN·m, smoothness is defined as B sec and volume resistivity is defined as C Ωcm, A, B and C satisfy the following equation after seasoning of the electrophotographic transfer paper in each of an environment of 10° C. and 15% RH and an environment of 23° C. and 50% RH:
1×10⁻²≦A/(logB×logC)≦3.0×10^{-2.}

(2) An electrophotographic transfer paper in which at least one surface of a base material containing pulp fiber has an image receiving surface comprising a coated layer containing pigment and adhesive, and a basis weight according to JIS P-8124 is 40 g/m² to 100 g/m², wherein at least one of the base material and the coated layer contains a cross-linking agent which causes a cross-linking reaction with a hydroxyl group or a carboxyl group.

(3) An image forming method comprising: forming a latent image on a latent image bearing body; developing the latent image using electrophotographic developer containing toner; transferring the developed toner image to a toner image receiving body by means of a transfer member; and fixing the toner image on the toner image receiving body by application of heat and pressure, wherein the toner image receiving body is electrophotographic transfer paper in which at least one surface of a base material containing pulp fiber has an image receiving surface comprising a coated layer containing pigment and adhesive and a basis weight according to JIS P-8124 is 40 g/m² to 100 g/m², and when bending stiffness in a cross direction is defined as A mN·m, smoothness is defined as B sec and volume resistivity is defined as C Ωcm, A, B and C satisfy the following equation after seasoning of the electrophotographic transfer paper in each of an environment of 10° C. and 15% RH and an environment of 23° C. and 50% RH:
1.0×10⁻²≦A/(logB×logC)≦3.0×10⁻².

(4) An image forming method, comprising: forming a latent image on a latent image bearing body; developing the latent image using electrophotographic developer containing toner; transferring the developed toner image to a toner image receiving body by means of a transfer member; and fixing the toner image on the toner image receiving body by application of heat and pressure, wherein the toner image receiving body is electrophotographic transfer paper in which at least one surface of a base material containing pulp fiber has an image receiving surface comprising a coated layer containing pigment and adhesive and a basis weight according to JIS P-8124 is 40 g/m² to 100 g/m², and at least one of the base material and the coated layer contains cross-linking agent which causes a cross-linking reaction with a hydroxyl group or a carboxyl group.

### BRIEF DESCRIPTION OF THE DRAWINGS

The present invention will be described in detail based on the following figures, wherein;

FIG. 1 is a schematic block diagram illustrating an example of an image output device to be used in an image forming method of the invention; and

FIG. 2 is a schematic block diagram illustrating an example of a fixing device to be used in the image forming method of the invention.

### DETAILED DESCRIPTION OF THE INVENTION

A first electrophotographic transfer paper of the invention is an electrophotographic transfer paper in which at least one surface of a base material containing pulp fiber has an image receiving surface comprising a coated layer containing pigment and adhesive and a basis weight according to JIS P-8124 is 40 g/m² to 100 g/m², wherein when bending stiffness in a cross direction is defined as A mN·m, smoothness is defined as B sec and volume resistivity is defined as C Ωcm, A, B and C satisfy the following equation after seasoning of the electrophotographic transfer paper in each of an environment of 10° C. and 15% RH and an environment of 23° C. and 50% RH:
1.0×10⁻²A/(logB×logC)≦3.0×10⁻².

The seasoning of paper means that paper is left at rest one by one on a mesh type shelf in the environment for seasoning, and humidity is adjusted for 24 or more hours.

On the other hand, when a flow direction of the pulp fiber (namely, paper making direction) is a machine direction at the time of manufacturing paper to be a base material, the cross direction means a direction which is defined as a direction perpendicular to the machine direction.

Physical property values in the invention are values measured by the following methods.

The basis weight is a value measured according to JIS P-8124.

The bending stiffness is a measured value obtained by a bending stiffness testing machine (model number: 2048-BF) manufactured by Kumagai Riki Kogyo based on ISO 2493 when a bending angle of a specimen with a width of 38 mm is set to 15° and a span of a stage is set to 10 mm.

The smoothness is a value measured by the method described in J Tapppi No. 5.

The volume resistivity is a value measured based on JIS K-6911, the disclosure of which is incorporated herein by reference, when an electrode of 50 mm φ is used and an applied voltage is 100 V.

A glossiness of the image receiving surface, which is mentioned later, is measured at an incident angle of 75° according to JIS P-8142, the disclosure of which is incorporated herein by reference.

Thickness and density of the electrophotographic transfer paper of the invention, mentioned later, are values measured according to JIS P-8118, the disclosure of which is incorporated herein by reference.

In the first electrophotographic transfer paper of the invention, when it is seasoned in the environments of 10° C. and 15% RH and 23° C. and 50% RH, A, B and C satisfy the following equation. As a result, when an image is formed by an indirect dry electrophotographic system, the density of an image to be formed is not lowered regardless of the paper being lightweight. The electrophotographic transfer paper has an excellent running property, namely, occurrence of defective run in a transfer section in various environments can be suppressed.
1.0×10⁻²≦A/(logB×logC)≦3.0×10⁻²

After the inventors repeatedly examined the mechanism of defective run due to adsorption of paper to a transfer member occurring in the transfer section, they found that the adsorption of the electrophotographic transfer paper to the transfer member in the transfer section (a portion where an image is transferred to the electrophotographic transfer paper of the invention by a transfer member or the like) is electrostatic adsorption. That is to say, the electrophotographic transfer paper is charged in the transfer section in order to transfer the toner to the electrophotographic transfer paper. However, although only for a short time, the electrophotographic transfer paper remains in the charged state even after the toner is transferred. For this reason, the electrophotographic transfer paper is attracted to the transfer member which is similarly in the charged state and is thereby adsorbed to it.

When the properties of the electrophotographic transfer paper that is easily adsorbed were examined in detail, it was recognized that the smoothness and the volume resistivity of the electrophotographic transfer paper greatly contribute to its easy adsorption. Although the cause of this is not clear, it is considered that the electrophotographic transfer paper is easily adsorbed to the transfer member because when the same electric charges are applied to the electrophotographic transfer paper, the time for attenuating the electric charges of the electrophotographic transfer paper with high volume resistivity is longer. It is considered that since the electrophotographic transfer paper with high smoothness has more electric charges which are present on its surface layer, it is easily adsorbed to the transfer member.

On the other hand, in addition to the adsorbability with respect to the transfer member, a force (repulsive force) for maintaining a posture of the electrophotographic transfer paper acts on the electrophotographic transfer paper. The inventors have recognized that the repulsive force is greatly influenced by the bending stiffness of the electrophotographic transfer paper, and that as the bending stiffness becomes stronger, defective run caused by the adsorption to the transfer member is reduced.

In recent color copying machines or printers with high performance, applied voltage for charging the electrophotographic transfer paper is fluctuated according to the ambient environment conditions in order to obtain a satisfactory image. For example, in the low-temperature/low-humidity environment, an amount of water in the electrophotographic transfer paper is lowered and the electric resistivity of the electrophotographic transfer paper becomes high. As a result, since the electrophotographic transfer paper becomes more difficult to charge, the applied voltage is set to be higher so that the electrophotographic transfer paper is charged. In general, in the low-temperature/low-humidity environment, even in the case of the same electrophotographic transfer paper, it is possible to use electrophotographic transfer paper which has just been taken out from the package and electrophotographic transfer paper which has been seasoned in the low-temperature/low-humidity environment. The electric resistivity greatly changes due to a change in moisture of the electrophotographic transfer paper, and thus the charged state of the electrophotographic transfer paper exhibits various states according to installation environments of the machines and the moisture states of the electrophotographic transfer paper.

More concretely, it is considered that when the adsorbability of the electrophotographic transfer paper to the transfer member exceeds the repulsive force from the transfer member, defective run occurs in the transfer section. A relationship between the repulsive force and the adsorbability of the electrophotographic transfer paper changes due to an output environment of images. For example in the high-temperature/high-humidity environment, since an amount of water in the electrophotographic transfer paper rises, electric conductivity of the electrophotographic transfer paper rises, and the volume resistivity decreases. That is to say, the adsorbability drops, and simultaneously the bending stiffness also drops due to the rise in the amount of water, so that the repulsive force drops. In contrast, in the low-temperature/low-humidity environment, the repulsive force rises, and the adsorbability rises. A variation in the bending stiffness due to the change in an amount of water of the electrophotographic transfer paper, and variations in the smoothness and the volume resistivity of the electrophotographic transfer paper depend on original properties of paper, and thus are not uniform. For this reason, even in an electrophotographic transfer paper which has a repulsive force that is sufficient to counter the adsorbability of the electrophotographic transfer paper to the transfer member in a low-temperature/low-humidity environment, the relationship between its adsorbability and its repulsive force is frequently reversed in a high-temperature/high-humidity environment.

The inventors have considered the above situation and conducted keen examination as to the properties of the electrophotographic transfer paper for which defective run does not occur in the transfer section. As a result, it has been found that, by controlling, in the following manner, a value obtained by dividing the bending stiffness in the cross direction by a value obtained by multiplying a logarithm of the smoothness of paper and a logarithm of the volume resistivity of paper, a lightweight electrophotographic transfer paper, whose running property in the transfer section in various environments is improved without decreasing the density of formed images, can be obtained.

When the first electrophotographic transfer paper of the invention is seasoned in the environments of 10° C. and 15% RH and 23° C. and 50% RH, A/(logB×logC) is necessarily 1.0×10⁻² to 3.0×10⁻² as mentioned above. 1.2×10⁻² to 2.5×10⁻² is preferable, and 1.5×10⁻² to 2.5×10⁻² is more preferable.

When A/(logB×logC) after seasoning the electrophotographic transfer paper in the environments of 10° C. and 15% RH and 23° C. and 50% RH is less than 1.0×10⁻², the adsorbability between the transfer member and the electrophotographic transfer paper in an image forming apparatus, mentioned later, becomes too strong. As a result, the adsorption of the electrophotographic transfer paper to the transfer member occurs, thereby causing defective run. On the other hand, when A/(logB×logC) after seasoning the electrophotographic transfer paper in the environments of 10° C. and 15% RH and 23° C. and 50% RH exceeds 3.0×10⁻², the volume resistivity tends to be small. For this reason, defective transfer, such as defective toner transfer such that the density of an image to be formed drops, occurs.

It is preferable that A/(logB×logC) after seasoning the first electrophotographic transfer paper of the invention in the environment of 30° C. and 85% RH is 1.0×10⁻² to 3.0×10⁻². When A/(logB×logC) after seasoning the first electrophotographic transfer paper in the environment of 30° C. and 85% RH is 1.0×10⁻² to 3.0×10⁻², the running property of the transfer section in various environments can be improved without lowering the density of images to be formed under the high-temperature/high-humidity condition.

It is preferable that A/(logB×logC) after seasoning the electrophotographic transfer paper in the environment of 30° C. and 85% RH is more preferably 1.2×10⁻² to 2.5×10⁻², and still more preferably 1.5×10⁻² to 2.5×10⁻².

When A/(logB×logC) after seasoning the electrophotographic transfer paper in the environment of 30° C. and 85% RH is less than 1.0×10⁻², the adsorbability between the transfer section and the electrophotographic transfer paper in the image forming apparatus, mentioned later, becomes too strong, and the adsorption of the electrophotographic transfer paper to the transfer member is generated, thereby causing defective run. On the other hand, when A/(logB×logC) after seasoning the electrophotographic transfer paper in the environment of 30° C. and 85% RH exceeds 3.0×10⁻², the volume resistivity tends to be small. For this reason, the defective transfer, such as the defective toner transfer such that the density of images to be formed drops, occasionally occurs.

As a means that sets A/(logB×logC) after seasoning the electrophotographic transfer paper in the environments of 10° C. and 15% RH, 23° C. and 50% RH and 30° C. and 85% RH to be 1.0×10⁻² to 3.0×10⁻², a method of controlling the values A, B and C is used. Particularly a method of suppressing the volume resistivity in the low-temperature/low-humidity environment, namely, lowering the adsorbability of the paper directing to the transfer member in the low-temperature/low-humidity environment, and a method of suppressing reduction in the bending stiffness of the paper in the high-temperature/high-humidity environment, namely, of increasing the repulsive force from the transfer member in the high-temperature/high-humidity environment (particularly high-temperature/high-humidity environment) are preferably used. The control of A/(logB×logC) is explained later.

It is preferable that the first electrophotographic transfer paper of the invention has a glossiness on the image receiving surface of not less than 30% which is measured according to JIS P-8142. As the glossiness is closer to 100%, a clearer image can be obtained. Not less than 40% is more preferable, and not less than 50% is still more preferable. When the glossiness is less than 30%, the image after output is not occasionally clear.

An example of the method of controlling the glossiness is a smoothing method. An example of the smoothing method is a method of using a smoothing device which is normally used, such as a super calender, a machine calender, or a soft-nip calender, after coating the coated layer to the base material. As a result, the electrophotographic transfer paper is easily finished so that its sheet density, mentioned later, becomes not less than 1.00 g/cm³ and the glossiness becomes not less than 30%.

The means that sets A/(logB×logC) to 1.0×10⁻² to 3.0×10⁻² is explained in detail below.

The volume resistivity after seasoning the electrophotographic transfer paper in the environment of 10° C. and 15% RH is preferably 5.0×10⁸ Ωcm to 1.0×10¹³ Ωcm. When the volume resistivity after seasoning the electrophotographic transfer paper in the environment of 10° C. and 15% RH does not reach 5.0×10⁸ Ωcm, the applied voltage is high in the environment of 10° C. and 15% RH. For this reason, electrification of the paper at the time of toner transfer is too strong, and thus a void phenomenon such that the toner transferred to the electrophotographic transfer paper is repelled easily occurs, thereby white patches tends to be caused.

On the other hand, when the volume resistivity after seasoning the electrophotographic transfer paper in the environment of 10° C. and 15% RH exceeds 1.0×10¹³ Ωcm, A/(logB×logC) is occasionally less than 1.0×10⁻². The adsorbability directing to the transfer member in the invention becomes strong, and thus the defective run easily occurs.

It is more preferable that the volume resistivity after seasoning the electrophotographic transfer paper in the environment of 10° C. and 15% RH is 1.0×10⁹ Ωcm to 5.0×10¹² Ωcm, and still more preferably 5.0×10⁹ Ωcm to 1.0×10¹² Ωcm.

In the first electrophotographic transfer paper of the invention, the volume resistivity after seasoning the electrophotographic transfer paper in the environment of 23° C. and 50% RH is preferably 5.0×10⁷ Ωcm to 1.0×10¹³ Ωcm, and more preferably 1.0×10⁸ Ωcm to 1.0×10¹² Ωcm.

Further, in the first electrophotographic transfer paper of the invention, the volume resistivity after seasoning the electrophotographic transfer paper in the environment of 30° C. and 85% RH is preferably 5.0×10⁷ Ωcm to 1.0×10¹² Ωcm, and more preferably 1.0×10⁸ Ωcm to 1.0×10¹¹ Ωcm.

On the other hand, in the electrophotographic transfer paper of the invention, the bending stiffness in the cross direction after seasoning the electrophotographic transfer paper in the environment of 30° C. and 85% RH is preferably not less than 0.20 mN·m. When the bending stiffness in the cross direction after seasoning the electrophotographic transfer paper in the environment of 30° C. and 85% RH is less than 0.20 mN·m, the repulsive force from the transfer member becomes too weak, thereby easily causing the defective run. The bending stiffness in the cross direction after seasoning the electrophotographic transfer paper in the environment of 30° C. and 85% RH is more preferably not less than 0.23 mN·m, and more preferably not less than 0.25 mN·m. As the bending stiffness in the cross direction of the electrophotographic transfer paper is larger, more satisfactory running property can be obtained. When easy turning-over of pages of books after the image output and bookbinding processes are, however, taken into consideration, the bending stiffness in the cross direction is preferably not more than 1.0 mN·m.

In the first electrophotographic transfer paper of the invention, the bending stiffness in the cross direction after seasoning the electrophotographic transfer paper in the environment of 10° C. and 15% RH is preferably not less than 0.30 mN·m, and more preferably not less than 0.38 mN·m. Further, not more than 1.0 mN·m is preferable.

In the first electrophotographic transfer paper of the invention, the bending stiffness in the cross direction after seasoning the electrophotographic transfer paper in the environment of 23° C. and 50% RH is preferably not less than 0.28 mN·m, and more preferably not less than 0.35 mN·m. Further, not more than 1.0 mN·m is preferable.

In the first electrophotographic transfer paper of the invention, the smoothness after seasoning the electrophotographic transfer paper in the environment of 10° C. and 15% RH is preferably 250 to 2000 sec, and more preferably 350 to 1500 sec.

In the first electrophotographic transfer paper of the invention, the smoothness after seasoning the electrophotographic transfer paper in the environment of 23° C. and 50% RH is preferably 220 to 1950 sec, and more preferably 300 to 1450 sec.

In the first electrophotographic transfer paper of the invention, the smoothness after seasoning the electrophotographic transfer paper in the environment of 30° C. and 85% RH is preferably 200 to 1800 sec, and more preferably 250 to 1400 sec.

In the first electrophotographic transfer paper of the invention, an example of the method of controlling (suppressing) the volume resistivity is a method of allowing at least one of the base material and the coated layer, mentioned later, to contain an electronically conductive substance. Examples of the electronically conductive substance are a metal conductive substance, a metallic oxide conductive substance, and a carbon conductive substance.

Examples of the metal conductive substance are gold powder, silver powder, copper powder, iron powder, nickel powder, zinc powder, and fibers of iron, copper and stainless.

Examples of the metallic oxide conductive substance are ZnO, TiO, SnO₂, Al₂O₃, In₂O₃, SiO₂, MgO, BaO and MoO₃. They may be used separately, or composite oxide of them may be used. The metallic oxide conductive substance preferably further contains different types of elements. For example, it is preferable that ZnO is doped with Al, In and the like, TiO is doped with Nb, Ta and the like, and SnO₂ is doped with Sb, Nb, halogen element and the like. SnO₂ doped with Sb is particularly preferable because it has less change in the electrical conductivity with time and high stability.

Examples of the carbon conductive substance are carbon fiber, graphite, graphite fiber, tube-shaped graphite fiber, activated carbon, charcoal, and diamond or the like.

An example of the method of controlling (suppressing) the volume resistivity is a method of allowing at least one of the base material and the coated layer, mentioned later, to contain conductive polymer. Examples of the conductive polymer are organic conductive polymers such as polyacetylene, polyaromatic vinylene, polypyrrole, polyaniline, polythiophene, and polyester. Dopant such as halogen, Lewis acid, proton acid, transition metal halide, alkali metal, alkyl ammonium ion, surface-active agent and amino acid can be added to these organic conductive polymers.

The drop in the bending stiffness of the first electrophotographic transfer paper of the invention, particularly in the high-temperature/high-humidity environment, is caused by decrease in the bonding force between the pulp fibers constituting the base material. The decrease in the bonding force is caused by increase in the distance between the pulp fibers due to the intrusion of water molecules between the pulp fibers and the formation of hydrogen bonds between the pulp fibers by the water molecules. In the invention, increase in the distance between the pulp fibers is prevented even if the amount of moisture in the paper increases in the high-temperature/high-humidity environment. Specifically, at least one of the base material and the coated layer, which are to be described later, are allowed to contain a substance such as a cross-linking agent that forms bonds other than hydrogen bonds with pulp fiber. As a result, the bending stiffness of paper can be controlled (lowering thereof is suppressed).

It is preferable that at least one of the base material and the coated layer contains a cross-linking agent which causes a cross-linking reaction with a hydroxyl group or a carboxyl group.

The cross-linking agent to be preferably used in the invention reacts to a hydroxyl group or a carboxyl group which are present in the pulp fiber. Examples of the cross-linking agent are isocyanate type cross-linking agent, melamine type cross-linking agent, epoxy type cross-linking agent, carbodiimide type cross-linking agent, and zirconium carbonate type cross-linking agent. Concrete examples of the isocyanate type cross-linking agent are monomers such as tolylene diisocyanate, diphenylmethane diisocyanate, naphthalene diisocyanate, tolidine diisocyanate, triphenylmethane triisocyanate, tris (isocyanate phenyl) thiophosphite, p-phenylene diisocyanate, xylene diisocyanate, bis (isocyanate methyl) cyclohexane, dicyclohexylmethane diisocyanate, hexamethylene diisocyanate, lysine diisocyanate, isophorone diisocyanate or the like, or trimethylolpropane adduct, modified isocyanurate, modified biuret, and modified allophanate of these monomers.

Examples of the melamine type cross-linking agent are trimethylolmelamine, hexamethylolmelamine, dimethylolurea dimethylolguanidine, dimethylolacetoguanamine, and etherified melamine resin which are obtained by reacting materials having polyfunctional amino group to formaldehyde.

The epoxy type cross-linking agent is a polyol glycidyl compound containing at least two epoxy groups. Its examples are butadiene dioxide type, diglycidyl ester type of hexadine dioxide and phthalic acid, diglycidyl ether type of bisphenol A, diglycidyl ether type of bisphenol F, triglycidyl ether amine type of para-aminophenol, diglycidyl ether type of aniline, tetraglycidyl ether type of phenylenediamine, diglycidyl ether type of sulfonamide, and triglycidyl ether type of glycerin.

Examples of the carbodiimide type cross-linking agent are dicyclohexylcarbodiimide, diisopropylcarbodiimide, and ethyldimethylamino propylcarbodiimide.

Examples of the zirconium carbonate type cross-linking agent are zirconium ammonium carbonate, zirconium potassium carbonate, and zirconium sodium carbonate or the like.

As the cross-linking agent, epoxy resin of diglycidyl ether type, diisopropyl carbodiimide, and zirconium ammonium carbonate are preferable.

Examples of the method of improving the bending stiffness of paper are (1) a method of heightening a degree of beating of pulp to be used and lowering a freeness to not more than 300 ml, (2) a method of adding wet paper strength additive or dry paper strength additive such as polyacrylamide, polyamide and polyamide epichlorohydrin resin to pulp slurry by not less than 0.8% per pulp, (3) a method of allowing the base material to internally contain polyvinyl alcohol or carboxymethyl cellulose whose polymerization degree is not less than 1000, or starch with comparatively high molecular weight (weight average molecular weight: not less than 100000) according to a size press method or the like, and (4) a method of using synthetic adhesive whose glass transition temperature is not less than 30° C. for the coated layer. These methods can be combined with the volume resistivity control method to be used in the low-temperature/low-humidity environment and the bending stiffness suppressing method to be used in the high-temperature/high-humidity environment.

The smoothness in the first electrophotographic transfer paper of the invention can be controlled by controlling the glossiness. Concretely, when the glossiness becomes high, the smoothness tends to be high, and when the glossiness becomes low, the smoothness tends to be low.

A second electrophotographic transfer paper of the invention is an electrophotographic transfer paper in which at least one surface of a base material containing pulp fiber has an image receiving surface comprising a coated layer containing pigment and adhesive, and a basis weight according to JIS P-8124 is 40 g/m² to 100 g/m², wherein at least one of the base material and the coated layer contains a cross-linking agent which causes a cross-linking reaction with a hydroxyl group or a carboxyl group. In the case where the electrophotographic transfer paper contains the cross-linking agent, the first electrophotographic transfer paper of the invention which satisfies the following relationship after the paper is seasoned in the environments of 10° C. and 15% RH and 23° C. and 50% RH can be easily obtained.
1.0×10⁻²≦A/(logB×logC)≦3.0×10⁻²

As the cross-linking agent in the second electrophotographic transfer paper of the invention, cross-linking agent similar to the cross-linking agent in the first electrophotographic transfer paper of the invention is preferably used, and its content preferably satisfies the above relationship.

It is necessary that the basis weight of the first and the second electrophotographic transfer paper of the invention (hereinafter, “the electrophotographic transfer paper of the invention”) is necessarily 40 g/m² to 100 g/m², preferably 45 g/m² to 90 g/m², and more preferably 45 g/m² to 85 g/m².

When the basis weight is less than 40 g/m², the basis weight is too small, and thus the thickness of the electrophotographic transfer paper becomes too thin, thereby causing defective run. When the basis weight exceeds 100 g/m², the coated paper cannot be thinned, thereby deteriorating its storage property.

The thickness of electrophotographic transfer paper of the invention is preferably 40 to 85 μm, and more preferably 45 to 75 μm.

The electrophotographic transfer paper of the invention has preferably paper density of not less than 1.00 g/cm³. In the case where the paper density is less than 1.00 g/cm³, when a lot of coated sheets are overlapped at the time of binding, the paper is bulked, and the storage property is occasionally deteriorated.

The paper density is preferably not less than 1.05 g/cm³, and more preferably not less than 1.10 g/cm³.

In the electrophotographic transfer paper of the invention, the pulp fiber to be used for the base material is not particularly limited, however pulp fiber to be used for base paper of general coated paper such as kraft pulp fiber, sulfite paper fiber, semichemical pulp fiber, chemiground pulp fiber, groundwood pulp fiber, refiner ground pulp fiber, and thermomechanical pulp fiber or the like is preferable when the price is taken into consideration. Fiber which is obtained by chemically qualifying cellulose or hemicellulose in these fibers can be used as the need arises.

Cotton pulp fiber, hemp pulp fiber, kenaf pulp fiber, biscose rayon fiber, cuprammonium rayon fiber, cellulose acetate fiber, polyvinyl chloride fiber, polyacrylonitrile fiber, polyvinylalcohol fiber, polyvinylidene chloride fiber, polyolefin fiber, polyurethane fiber, polyvinyl chloride, polyvinyl alcohol copolymer, fluorocarbon fiber, glass fiber, carbon fiber, alumina fiber, metal fiber, silicon carbide fiber and the like can be used separately or can be combined to be used. Fiber, which is obtained by impregnating synthetic resin such as polyethylene, polypropylene, polystyrene, polyvinyl chloride and polyester into the pulp fiber or heat-fusing such synthetic resin into the pulp fiber, can be used as the need arises.

On the other hand, taking the recent environmental problem into consideration, it is desirable that high quality or medium quality of recycled fiber is added, and its blending quantity is determined according to applications. The blending quantity is not less than 10%, preferably not less than 30%, and more preferably not less than 50% in the entire pulp fiber.

As the base material constituting the electrophotographic transfer paper of the invention, filler can be used in order to improve coating suitability and adjust opacity and brightness after coating. Examples of the filler are ground calcium carbonate, precipitated calcium carbonate, kaolin, calcined clay, Piolo-ferrite, sericite, silic acid such as talc, inorganic filler such as titanium dioxide, urea resin, and organic pigment such as styrene. The filler is, however, not limited to them. The blending quantity of the filler is not particularly limited, however, 1 to 20 mass %, more preferably 3 to 15 mass % of the filler with respect to total solids of the pulp slurry is used.

The base material constituting the electrophotographic transfer paper of the invention internally contains various chemicals such as a sizing agent, or they are externally added to it. Examples of the sizing agent include a rosin type sizing agent, a synthetic sizing agent, a petroleum resin sizing agent, and a neutral sizing agent, and it is also possible to use a combination of a sizing agent such as aluminum sulfate and a fixing agent for the fibers such as cationic starch. From the viewpoint of paper storage stability after copying in electrophotographic copying machines and printers, a neutral sizing agent such as an alkenyl succinic anhydride sizing agent, alkylketene dimer, alkenylketene dimer, neutral rosin, petroleum size, olefin resin or styrene-acrylic resin is preferable.

In order to adjust the electrical resistance of the electrophotographic transfer paper, besides the above-mentioned electronically conductive substance, inorganic substances such as sodium chloride, potassium chloride, calcium chloride and sodium sulfate, organic substances such as alkylphosphate ester, alkylsulfate ester, sulfonic acid sodium salt and quaternary ammonium salt can be used independently or they can be mixed to be used.

A paper strength additive can be added to the base material internally or externally as the need arises. Examples of paper strength additive include starch, denatured starch, vegetable gum, carboxymethyl cellulose, polyvinyl alcohol, polyacrylamide, urea-formaldehyde resin, melamine-formaldehyde resin, dialdehyde starch, polyethyleneimine, epoxidized polyamide, epichlorohydrine resin, methylolpolyamide, and chitosan derivative. These materials can be used independently or can be mixed to be used.

Further, various assistants such as dye and pH regulator which is mixed with normal base paper for coated paper are suitably used.

From the viewpoint such that feeling similar to that of conventional coated paper is provided and the manufacturing cost is decreased, it is necessary that the electrophotographic transfer paper of the invention has the image receiving surface comprising the coated layer containing pigment and adhesive on at least one surface of the base material. It is preferable that both the surfaces of the base material have the image receiving surface comprising the coated layer.

The electrophotographic transfer paper of the invention has the image receiving surface comprising the coated layer containing pigment and adhesive on at least one surface of the base material. Examples of the pigment in the coated layer include pigment to be used for normal coated paper such as mineral pigment such as ground calcium carbonate, precipitated calcium carbonate, titanium dioxide, aluminum hydroxide, satin white, talc, calcium sulfate, barium sulfate, zinc oxide, magnesium oxide, magnesium carbonate, amorphous silica, colloidal silica, white carbon, kaolin, calcined kaolin, delaminated clay, alumino silicate, sericite, bentonite and smectite, polystyrene resin fine particle, urea-formaldehyde resin fine particle, microhollow particle and another organic pigment. They can be used independently or plural pigment can be combined to be used.

As the adhesive in the coated layer, synthetic adhesive or natural adhesive can be used.

Examples of the synthetic adhesive include various copolymers such as styrene-butadiene, styrene-acryl, ethylene-vinyl acetate, butadiene-methyl methacrylate and vinyl acetate-butyl acrylate, and polyvinyl alcohol, maleic anhydride copolymer, acrylic acid-methyl methacrylate copolymer. One or more kinds of these synthetic adhesives can be used according to objects. The content of the synthetic adhesive is preferably 5 to 50 parts by mass per 100 parts by mass of pigment, and more preferably 10 to 30 parts by mass.

Examples of the natural adhesive are generally known adhesive such as starch oxide, esterified starch, enzyme denatured starch, chilled water soluble starch which is obtained flash drying them, casein and soy protein. The content of the natural adhesive is preferably 0.1 to 50 parts by mass per 100 parts by mass of pigment, and more preferably 2 to 30 parts by mass.

Various assistants such as dispersing agent, thickening agent, water retaining agent, deforming agent and water resistant additive, which are mixed with the normal pigment for coated paper, are suitably used for the coated layer of the electrophotographic transfer paper of the invention as the need arises.

The coated layer of the electrophotographic transfer paper of the invention is formed in such a manner that one layer or plural layers of coating composition which is prepared so as to contain the above components is (are) applied to one surface of the base material by on-machine coating or off-machine coating according to the coating weight as dry weight. At this time, a coating device which is used for the manufacturing of general coated paper such as a blade coater, an air knife coater, a roll coater, a reverse roll coater, a bar coater, a curtain coater, a die slot coater or a gravure coater is used. In this case, the coating weight as dry weight is preferably 2 to 15 g/m².

The electrophotographic transfer paper of the invention manufactured under the such a condition is packaged normally by moisture-resistant packing paper such as polyethylene laminated paper or polypropylen so that moisture absorption and dehumidity do not occur at the time of storage until the paper reaches the customers.

In this case, it is preferable that the moisture percentage of the coated paper just after the package is opened is adjusted at the dry and calender step using a paper machine and a coater so as to be preferably 3 to 6.5%, and more preferably 4.5 to 5.5%.

An image forming method of the invention is including forming a latent image on a latent image bearing body, developing the latent image using an electrophotographic developer containing toner, transferring the developed toner image to a toner image receiving body by a transfer member, and fixing the toner image on the toner image receiving body by application of heat and pressure. The toner image receiving body is the electrophotographic transfer paper of the invention. The image forming method of the invention is not limited as long as it includes the above steps, and a method or the like of intermediately overlapping the developed toner image as a color toner image on a belt or the like (intermediate transfer belt), collectively transferring the color toner image to the toner image receiving body, and heating and fusing so as to fix the color toner image to the toner image receiving body may be adopted.

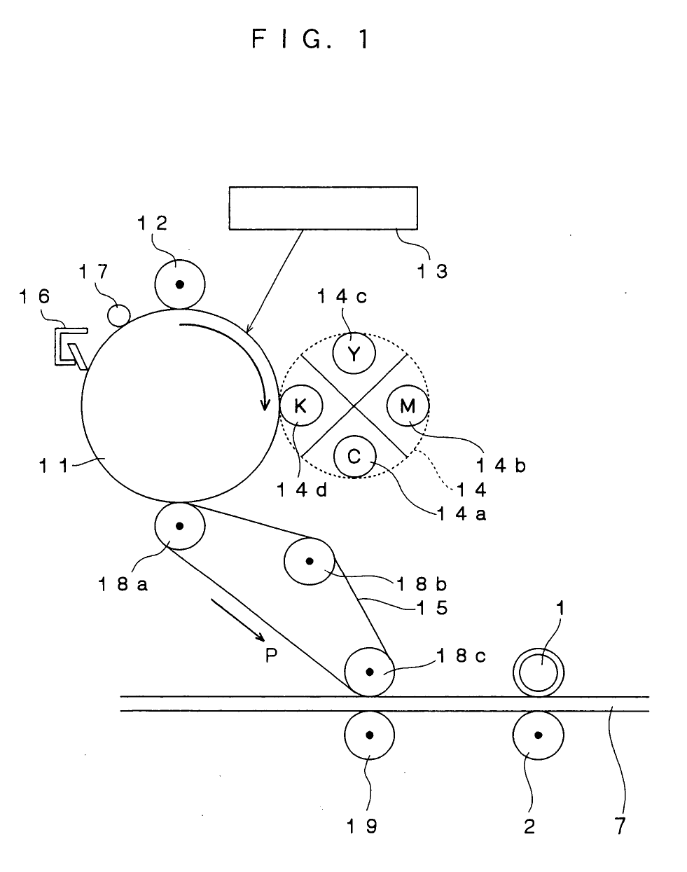

FIG. 1 is a schematic block diagram illustrating one example of an image forming apparatus to be used suitably for the image forming method of the invention. The image forming apparatus shown in FIG. 1 has a photosensitive body (a latent image bearing body) 11, and a roller type charger 12, an exposing device 13, a developing device 14 containing developing units 14a, 14b, 14c and 14d loaded with developers of cyan, magenta, yellow and black, a belt-shaped intermediate transfer body 15, a cleaner 16, and a photo-static eliminator 17 are arranged in this order around the photosensitive body 11. The intermediate transfer body 15 is stretched among spindle rollers 18a, 18b and 18c. The spindle roller 18a pressure-contacts with the photosensitive body 11 via the intermediate transfer body 15. The spindle roller 18c pressure-contacts with a transfer roller (transfer member) 19 via a toner image receiving body 7. Further, the image forming apparatus further has a heated roller fixing device including a heating roller 1 and a pressurizing roller 2 which fix the toner image transferred to the toner image receiving body 7 by the transfer roller 19.

The image forming apparatus shown in FIG. 1 forms an image in the following manner. The photosensitive body 11 charged by the roller type charger 12 is exposed by the exposing device 13 based on image information of cyan, magenta and yellow so that latent images are formed on the photosensitive body 11. The latent images on the photosensitive body 11 are developed by the developing units 14a, 14b, 14c and 14d in the developing device 14 so that toner images are formed. The developed toner images are transferred onto the belt-shaped intermediate transfer body 15. The toner images on the intermediate transfer body 15 are moved between the spindle roller 18c and the transfer roller 19 which pressure-contacts with the spindle roller 18c via the intermediate transfer body 15 according to an advance of the intermediate transfer body 15 to a direction of arrow P. The toner images on the intermediate transfer body 15 pass between the spindle roller 18c and the transfer roller 19 (nip portion) which pressure-contacts with the spindle roller 18c via the toner image receiving body 7. At this time, the toner images are transferred to the toner image receiving body 7 which is inserted into the nip portion. The toner images transferred onto the toner image receiving body 7 are fixed to the toner image receiving body 7 by allowing the toner image receiving body 7 to pass between the heating roller 1 and the pressurizing roller 2, so that an image is formed. After the toner images on the photosensitive body 11 are transferred to the toner image receiving body 7, toner images remaining on the photosensitive body 11 are removed by the cleaner 16. Residual electric charges are eliminated by the photo-static eliminator 17, and the apparatus prepares next image forming.

As the fixing device to be used for the image forming method of the invention, a contact type thermal fixing device can be used. Examples of such a fixing device are a heated roller fixing device which has a heating roller having a rubber elastic layer on a cored sleeve and a fixing member surface layer as the need arises and a pressurizing roller having a rubber elastic layer on a cored bar and a fixing member surface layer as the need arises, and a fixing device which includes a combination of a roller and a belt or a belt and a belt instead of the combination of the rollers.

A material which has excellent heat resistance, strong strength against deformation and excellent thermal conductivity is selected as a core of the fixing member. In the case of the roller-shaped fixing device, aluminum, iron, copper and the like are selected, and in the case of the belt-type fixing device, a polyimide film, a stainless belt and the like are selected. It is preferable that an elastic rubber layer normally made of silicone rubber, fluoro rubber or the like is provided on a surface of the roller-shaped core.

The fixing member may contain various additives according to objects, and thus may contain, for example, carbon black, metallic oxide, ceramic particles such as SiC or the like in order to improve abrasion quality and control resistance.

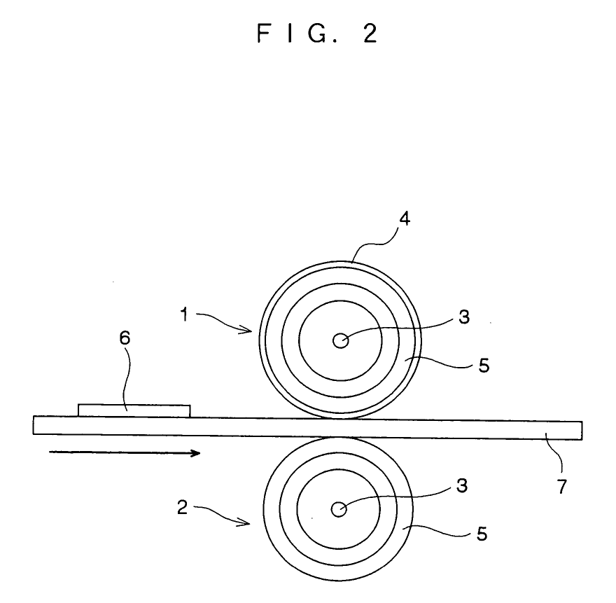

The fixing step using the electrophotographic transfer paper of the invention is explained in detail with reference to FIG. 2. A fixing device shown in FIG. 2 is such that the fixing member has a roller shape, and has the heating roller 1, the pressurizing (pressure-contacting) roller 2 which is arranged so as to be opposed to the heating roller 1, a heating source 3 for heating the heating roller 1, and a fixing member surface layer 4 on the surface of the heating roller 1. An elastic layer 5 is formed on the surface of the heating roller 1. When the toner image receiving body 7 formed with the toner image 6 passes between the pressurizing roller 2 and the heating roller 1, it is heated and pressurized so that the image is fixed.

The fixing device shown in FIG. 2 may include a cleaning member for removing toner adhered to the surface of the heating roller 1, a heating source 3 for heating the pressurizing roller 2, a claw (finger) for peeling the toner image receiving body from the heating roller 1, and the like as the need arises. The heating source 3 in the fixing device shown in FIG. 2 is controlled by a temperature control device (not shown).

The heating roller 1 and/or the pressurizing roller 2 preferably have (has) the elastic layer 5 with a monolayer or multi-layer structure, and the thickness of the elastic layer is preferably 0.1 to 3 mm, more preferably 0.5 to 2 mm. The elastic layer 5 uses heat-resistant rubber such as silicon rubber and fluoro rubber, and the hardness of the rubber is preferably not more than 60. When the fixing member has the elastic layer 5, the fixing member deforms according to unevenness of the toner image 6 on the toner image receiving body 7, so that smoothness on the surface of the image after fixing can be improved. Therefore, this case is advantageous. When the thickness of the elastic layer exceeds 3 mm, the heat capacity of the fixing member becomes large, a long time is required for heating the fixing member to a desired temperature, and energy consumption increases. For this reason, this case is not preferable. When the thickness of the elastic layer is less than 0.1 mm, namely, too small, the fixing member cannot be deformed according to the unevenness of the tone image, so that irregular fusing occurs. Further, distortion of the elastic layer which is effective for peeling cannot be obtained, and thus this case is not preferable.

The toner and the developer to be used in the image forming method of the invention are not particularly limited, however the following toner can be used suitably.

As the resin component of the toner, in general, polyester resin or styrene-acrylic resin is mainly used.

As the toner producing method, any producing methods such as a pulverizing method and a polymerizing method may be used. A preferable method is such that resin particle dispersion in which resin particles are dispersed is mixed with coloring agent dispersion in which coloring agent is dispersed, the resin particles and the coloring agent are aggregated into a toner particle diameter, and the obtained aggregate is heated to a temperature which is not less than glass transition point of the resin and fused.

In the toner, the form factor (SF1) of the toner expressed by the following equation (1) is preferably in a range of 100 to 140.
SF1=(ML²×π/4A)×100 equation (1)

(In the equation, ML designates a maximum length of the toner, and A designates a projected area of the toner.)

When the form factor SF1 exceeds 140, toner flowing properties are deteriorated, and initial transfer properties are occasionally influenced. An average value of the toner form factor SF1 can be calculated by the following manner, for example. That is to say, a photomicrograph of the toner dispersed onto a slide glass is taken into a Luzex image analysis device through a video camera, and the form factors SF1 of not less than 100 toners are calculated so that its average value is obtained.

In the invention, a volume average particle diameter of the toner is preferable falls within a range of 2 to 8 μm, more preferably in a range of 3 to 7 μm. When the volume average particle diameter of the toner is less than 2 μm, electrification characteristic is easily insufficient, and developing characteristic is occasionally deteriorated. For this reason, this case is not preferable. On the other hand, when the volume average particle diameter exceeds 8 μm, resolution property is occasionally deteriorated, and thus this case is not preferable.

The volume average particle diameter of the toner means a particle diameter such that cumulative volume from a small diameter side becomes 50%. It can be measured by a measuring instrument such as Coulter counter TA-IL (manufactured by Nikkaki) or Multisizer II (manufactured by Nikkaki).

As to the particle size distribution of the toner, volume average particle size distribution index GSDv is preferably not more than 1.28, and more preferably not more than 1.25. Toner with sharp particle size distribution can be obtained by an emulsification aggregation method. When GSDv exceeds 1.28, sharpness property and resolution property of the image are deteriorated, and thus this case is not preferable.

The volume average particle size distribution index GSDv of the toner means a square root of a ratio (D₈₄ᵥ/D₁₆ᵥ) wherein a particle diameter D₁₆ᵥ refers to a particle diameter for which cumulative volume from a small diameter side becomes 16%, and a particle diameter D₈₄ᵥ refers to a particle diameter for which the cumulative volume from a small diameter side becomes 84%. This can be measured by a similar device to that used for the volume average particle diameter.

The electrophotographic developer is not particularly limited as long as it contains toner, and it can have a suitable component according to objects.

The electrophotographic developer is prepared as electrophotographic developer with one component system when the toner is used independently, and is prepared as an electrophotographic developer with two component system when toner is combined with a carrier.

The carrier which is used as the electrophotographic developer with two component system is not particularly limited, and a publicly known carrier such as a resin-coated carrier described in Japanese Patent Application Laid-Open Nos. 62-39879 and 56-11461.

A mixture ratio of the toner and the carrier in the electrophotographic developer is not particularly limited, and can be selected suitably according to objects.

In the image forming method of the invention, when the electrophotographic transfer paper of the invention is used as the toner image receiving body 7, the running property in the transfer section (the portion where the transfer roller 19 pressure-contacts with the spindle roller 18c via the toner image receiving body 7) in various environments can be improved without lowering the density of the image to be formed.

### EXAMPLES

The invention is concretely explained by examples. However, the invention is not limited thereto. “Part” in the examples and comparative examples means “part by mass” unless otherwise noted. Similarly “%” means mass %.

### Example 1

With respect to 100 parts of pulp fiber solid content, 7 parts of precipitated calcium carbonate (Tama pearl TP-121) manufactured by Okutama Kogyo Co., Ltd.), 0.5 parts of aluminum sulfate, 0.6 parts of cationic starch (product name: MS4600 manufactured by Nihon Shokuhin Kako Co., Ltd.), 0.1 parts of alkenyl succinic anhydride (product name: FIBRAN 81 (manufactured by Oji National Co., Ltd.) and 1.0 parts of an electronically conductive substance which is TiO₂ coated with Sb-doped SnO₂ (product name: FT2000 manufactured by Ishihara Sangyo Kaisha, Ltd.) are added to pulp slurry which is obtained by beating pulp slurry with 100 parts of bleached kraft pulp (LBKP; Laubholz bleached kraft pulp) using a Niagara beater (manufactured by Kumagai Riki Kogyo) and whose freeness is 250 ml, and an obtained mixture is diluted with white water, so that pulp slurry whose solid content density is 0.3% is prepared.

After the pulp slurry is agitated for 2 hours, paper is made by using an Oriented Sheet Former (manufactured by Kumagai Riki Kogyo), and polyvinyl alcohol (JC-25 manufactured by JAPAN VAM & POVAL Co., Ltd.) whose degree of polymerization is 2500 is applied to the wet web by a size press machine so that a coating weight becomes 2.5 g/m² by dry weight. After the wet web is dried, it is subjected to a smoothing process by a machine calender so that an OUKEN smoothness described in J Tappi No. 5 becomes 30 sec, and a base material whose basis weight is 49 g/m² is obtained.

Next, 3% (referring, here and below, to a solid ratio with respect to the pigment) of starch oxide (Ace A manufactured by Oji Cornstarch Co., Ltd.), 12% of synthesized adhesive whose glass transition temperature is 0° C. (LX407H manufactured by Zeon Corporation) and 0.3% of dispersant (Aron T-40 manufactured by Toagosei Co., Ltd.) are mixed, as adhesive, with 100% of a pigment component including 23% of precipitated calcium carbonate (product name: Tama Pearl T-123 manufactured by Okutama Kogyo Co., Ltd.), 75% of kaolin (Ultra White 90 manufactured by Engelhard Corporation) and 2% of the electronic conductive substance (product name: FT-2000 manufactured by Ishihara Sangyo Kaisha Ltd.). As a result, a coating composition as a coating liquid for forming the coated layer is prepared.

The coating composition is applied to both surfaces of the base material by a blade coater so that a dry weight on one surface becomes 7.5 g/m². After the base material is dried, it is subject to a smoothing process by a super calender with a roll temperature of 50° C. so that the glossiness becomes 54%. As a result, an electrophotographic transfer paper with a basis weight of 64 g/m² is obtained.

### Example 2

With respect to 100 parts of the pulp fiber solid content, 8 parts of precipitated calcium carbonate (product name: Tama Pearl TP-121 manufactured by Okutama Kogyo Co., Ltd.), 0.5 parts of aluminum sulfate, 0.6 parts of cationic starch (product name: MS4600 manufactured by Nihon Shokuhin Kako Co., Ltd.), 0.1 parts of alkenyl succinic anhydride (product name: FIBRAN 81 manufactured by Oji National Co., Ltd.) and 1.0 parts of zirconium carbonate ammonium salt (product name: CALTA BOND ZA liquid manufactured by Clariant Japan KK) are added to pulp slurry which is obtained by beating pulp slurry with 100 parts of LBKP using a Niagara beater (manufactured by Kumagai Riki Kogyo) and whose freeness is 280 ml, and an obtained mixture is diluted with white water, so that pulp slurry whose solid content density is 0.3% is prepared.

After the pulp slurry is agitated for 2 hours, paper is made by using the Oriented Sheet Former (manufactured by Kumagai Riki Kogyo), and polyvinyl alcohol (JC-25 manufactured by JAPAN VAM & POVAL Co., Ltd.) whose degree of polymerization is 2500 is applied to the wet web by the size press machine so that a coating weight becomes 3.5 g/m² by dry weight. After the wet web is dried, it is subjected to the smoothing process by the machine calender so that an OUKEN smoothness becomes 30 sec, and a base material whose basis weight is 49 g/m² is obtained.

Next, 3% (referring, here and below, to a solid ratio with respect to the pigment) of starch oxide (Ace A manufactured by Oji Cornstarch Co., Ltd.), 12% of synthesized adhesive whose glass transition temperature is 0° C. (LX407H manufactured by Zeon Corporation) and 0.3% of dispersant (Aron T-40 manufactured by Toagosei Co., Ltd.) are mixed, as adhesive, with 100% of a pigment component including 40% of precipitated calcium carbonate (product name: Tama Pearl T-123 manufactured by Okutama Kogyo Co., Ltd. and 60% of kaolin (Ultra White 90 manufactured by Engelhard Corporation). As a result, a coating composition as a coating liquid for forming the coated layer is prepared.

The coating composition is applied to both surfaces of the base material by the blade coater so that a dry weight on one surface becomes 7.5 g/m². After the base material is dried, it is subject to a smoothing process by the super calender with a roll temperature of 50° C. so that the glossiness becomes 53%. As a result, an electrophotographic transfer paper with a basis weight of 64 g/m² is obtained.

### Example 3

With respect to 100 parts of pulp fiber solid content, 8 parts of precipitated calcium carbonate (product name: Tama Pearl TP-121 manufactured by Okutama Kogyo Co., Ltd.), 0.5 parts of aluminum sulfate, 0.6 parts of cationic starch (product name: MS4600 manufactured by Nihon Shokuhin Kako Co., Ltd.), 0.1 parts of alkenyl succinic anhydride (product name: FIBRAN 81 manufactured by Oji National Co., Ltd.), 2.0 parts of zirconium carbonate ammonium salt (product name: CALTA BOND ZA liquid manufactured by Clariant Japan KK) and 1.5 parts of the electronically conductive substance which is TiO₂ coated with Sb-doped SnO₂ (product name: FT2000 manufactured by Ishihara Sangyo Kaisha, Ltd.) are added to pulp slurry which is obtained by mixing pulp slurry obtained by beating pulp slurry with 80 parts of LBKP using a Niagara beater (manufactured by Kumagai Riki Kogyo) and whose freeness is 350 ml with pulp slurry obtained by beating pulp slurry with 20 parts of NBKP using a Niagara beater (manufactured by Kumagai Riki Kogyo) and whose freeness is 450 ml, and an obtained mixture is diluted with white water, so that pulp slurry whose solid content density is 0.3% is prepared.

After the pulp slurry is agitated for 2 hours, paper is made by using the Oriented Sheet Former (manufactured by Kumagai Riki Kogyo), and starch oxide (Ace B manufactured by Oji Cornstarch Co., Ltd.) is applied to the wet web by a size press machine so that a coating weight becomes 1.5 g/m² by dry weight. After the wet web is dried, it is subjected to a smoothing process by a machine calender so that the OUKEN smoothness becomes 30 sec, and a base material whose basis weight is 44 g/m² is obtained.

Next, 3% (referring, here and below, to a solid ratio with respect to the pigment) of starch oxide (Ace A manufactured by Oji Cornstarch Co., Ltd.), 12% of synthesized adhesive whose glass transition temperature is 56° C. (LX433C manufactured by Zeon Corporation) and 0.3% of dispersant (Aron T-40 manufactured by Toagosei Co., Ltd.) are mixed, as adhesive, with 100% of a pigment component including 30% of precipitated calcium carbonate (product name: Tama Pearl T-123 manufactured by Okutama Kogyo Co., Ltd. and 70% of kaolin (Ultra White 90 manufactured by Engelhard Corporation). As a result, a coating composition as a coating liquid for forming the coated layer is prepared.

The coating composition is applied to both surfaces of the base material by the blade coater so that a dry weight on one surface becomes 10 g/m². After the base material is dried, it is subject to a smoothing process by the super calender with a roll temperature of 50° C. so that the density becomes 1.13 g/cm³ and the glossiness becomes 52%. As a result, an electrophotographic transfer paper with a basis weight of 64 g/m² is obtained.

### Example 4

With respect to 100 parts of pulp fiber solid content, 8 parts of precipitated calcium carbonate (product name: Tama Pearl TP-121 manufactured by Okutama Kogyo Co., Ltd.), 0.5 parts of aluminum sulfate, 0.6 parts of cationic starch (product name: MS4600 manufactured by Nihon Shokuhin Kako Co., Ltd.), 0.1 parts of alkenyl succinic anhydride (product name: FIBRAN 81 manufactured by Oji National Co., Ltd.), 1.2 parts of an electronically conductive substance including Sb-doped SnO₂ (product name: SN-100P manufactured by Ishihara Sangyo Kaisha, Ltd.) are added to pulp slurry which is obtained by beating pulp slurry with 100 parts of LBKP using a Niagara beater (manufactured by Kumagai Riki Kogyo) and whose freeness is 370 ml, and an obtained mixture is diluted with white water, so that pulp slurry whose solid content density is 0.3% is prepared.

After the pulp slurry is agitated for 2 hours, paper is made by using the Oriented Sheet Former (manufactured by Kumagai Riki Kogyo), and starch oxide (Ace B manufactured by Oji Cornstarch Co., Ltd.) is applied to the wet web by a size press machine so that a coating weight becomes 1.5 g/m² by dry weight. Zirconium carbonate ammonium salt (product name: CALTA BOND ZA liquid manufactured by Clariant Japan KK) is applied to the wet web by a size press machine so that a coating weight becomes 1.5 g/m² by dry weight. After the wet web is dried, it is subjected to a smoothing process by the machine calender so that the OUKEN smoothness becomes 30 sec, and a base material whose basis weight is 46 g/m² is obtained.

Next, 3% (referring, here and below, to a solid ratio with respect to the pigment) of starch oxide (Ace A manufactured by Oji Cornstarch Co., Ltd.), 14% of synthesized adhesive whose glass transition temperature is 26° C. (Nipol 1577 manufactured by Zeon Corporation) and 0.3% of dispersant (Aron T-40 manufactured by Toagosei Co., Ltd.) are mixed, as adhesive, with 100% of a pigment component including 27.5% of precipitated calcium carbonate (product name: Tama Pearl T-123 manufactured by Okutama Kogyo Co., Ltd., 70% of kaoline (Ultra White 90 manufactured by Engelhard Corporation) and an electric conductive substance (product name: FT-2000 manufactured by Ishihara Sangyo Kaisha Ltd.). As a result, a coating composition as a coating liquid for forming the coated layer is prepared.

The coating composition is applied to both surfaces of the base material by the blade coater so that a dry weight on one surface becomes 9 g/m². After the base material is dried, it is subject to a smoothing process by the super calender with a roll temperature of 50° C. so that the density becomes 1.19 g/cm³ and the glossiness becomes 57%. As a result, an electrophotographic transfer paper with a basis weight of 64 g/m² is obtained.

### Comparative Example 1

With respect to 100 parts of pulp fiber solid content, 8 parts of precipitated calcium carbonate (product name: Tama Pearl TP-121 manufactured by Okutama Kogyo Co., Ltd.), 0.5 parts of aluminum sulfate, 0.6 parts of cationic starch (product name: MS4600 manufactured by Nihon Shokuhin Kako Co., Ltd.) and 0.1 parts of alkenyl succinic anhydride (product name: FIBRAN 81 manufactured by Oji National Co., Ltd.) are added to pulp slurry which is obtained by beating pulp slurry with 100 parts of LBKP using a Niagara beater (manufactured by Kumagai Riki Kogyo) and whose freeness is 370 ml. An obtained mixture is diluted with white water; so that pulp slurry whose solid content density is 0.3% is prepared.

After the pulp slurry is agitated for 2 hours, paper is made by using the Oriented Sheet Former (manufactured by Kumagai Riki Kogyo), and starch oxide (Ace B manufactured by Oji Cornstarch Co., Ltd.) is applied to the wet web by a size press machine so that a coating weight becomes 1.5 g/m² by dry weight. After the wet web is dried, it is subjected to a smoothing process by the machine calender so that the OUKEN smoothness becomes 30 sec, and a base material whose basis weight is 44 g/m² is obtained.

Next, 3% (referring, here and below, to a solid ratio with respect to the pigment) of starch oxide (Ace A manufactured by Oji Cornstarch Co., Ltd.), 12% of synthesized adhesive (LX407H manufactured by Zeon Corporation) and 0.3% of dispersant (Aron T-40 manufactured by Toagosei Co., Ltd.) are mixed, as adhesive, with 100% of a pigment component including 30% of precipitated calcium carbonate (product name: Tama Pearl T-123 manufactured by Okutama Kogyo Co., Ltd.) and 70% of kaolin (Ultra White 90 manufactured by Engelhard Corporation). As a result, a coating composition as a coating liquid for forming the coated layer is prepared.

The coating composition is applied to both surfaces of the base material by the blade coater so that a dry weight on one surface becomes 8 g/m². After the base material is dried, it is subject to a smoothing process by the super calender with a roll temperature of 50° C. so that the glossiness becomes 53%. As a result, an electrophotographic transfer paper with a basis weight of 64 g/m² is obtained.

### Comparative Example 2

With respect to 100 parts of pulp fiber solid content, 6 parts of kaolin (Ultra White 90 manufactured by Engelhard Corporation), 0.5 parts of aluminum sulfate, rosin sizing agent (product name: Sizepine E-50 manufactured by Arakawa Chemical Industries, Ltd.) and 3.2 parts of cationic starch (product name: MS4600 manufactured by Nihon Shokuhin Kako Co., Ltd.) are added to pulp slurry which is obtained by beating pulp slurry with 100 parts of LBKP using a Niagara beater (manufactured by Kumagai Riki Kogyo) and whose freeness is 350 ml, and an obtained mixture is diluted with white water, so that pulp slurry whose solid content density is 0.3% is prepared.

After the pulp slurry is agitated for 2 hours, paper is made by using the Oriented Sheet Former (manufactured by Kumagai Riki Kogyo), and the paper is dried so that paper moisture becomes 5%. As a result, the base material whose basis weight is 61.5 g/m² is obtained.

Next, 25% (solid ratio with respect to the pigment) of synthetic adhesive (LX407H manufactured by Zeon Corporation) is mixed as adhesive with 100% of a pigment component including 100% of precipitated calcium carbonate (product name: Tama Pearl T-123 manufactured by Okutama Kogyo Co., Ltd.). As a result, a coating composition as a coating liquid for forming the coated layer is prepared.

The coating composition is applied to both surfaces of the base material by silkscreen coating so that a dry weight on one surface becomes 1.25 g/m² (a dry weight of calcium carbonate is 1.0 g/m²). The base material is subject to a smoothing process by the super calender with a roll temperature of 50° C. so that center line roughness (Ra) of the surface becomes 0.5 μm and rigidity in the cross direction of paper becomes 17.2 cm. As a result, an electrophotographic transfer paper with a basis weight of 64 g/m² and the glossiness of 18% is obtained.

This electrophotographic transfer paper is manufactured similarly to the method described in the example 3 of Japanese Patent Application Laid-Open No. 2000-172001.

### Comparative Example 3

The chemicals which is applied to the made sheet by the size press machine is changed from the starch oxide into polyvinyl alcohol (JC-25), and its coating weight is 2.5 g/m² by dry weight. Except for them, the electrophotographic transfer paper whose glossiness is 52% and basis weight is 64 g/m² is obtained similarly to the comparative example 1.

### Comparative Example 4

A number of injecting times of the Oriented sheet former (manufactured by Kumagai Riki Kogyo) is adjusted, and paper is made so that the basis weight of the base material becomes 60 g/m². Both the surfaces of the base material are coated with the coated layer by the blade coater so that a coating weight on one surface becomes 2 g/m² by dry weight, and the basis weight after coating with the coated layer is 64 g/m². Except for them, the electrophotographic transfer paper whose glossiness is 25% is obtained similarly to the comparative example 1.

### Comparative Example 5

64.0 g/m² of OK Coat L (manufactured by Oji Paper Co., Ltd.) which is a commercially available printing coated paper is used as the electrophotographic transfer paper.

### Comparative Example 6

64.0 g/m² of Royal Coat L (manufactured by Oji Paper Co., Ltd.) which is a commercially available printing coated paper is used as the electrophotographic transfer paper.

### Comparative Example 7

64.0 g/m² of Pegasus (manufactured by Nippon Paper Industries Co., Ltd.) which is a commercially available finely coated paper for printing is used as the electrophotographic transfer paper.

### Comparative Example 8

With respect to 100 parts of pulp, 1.0 parts of electronically conductive substance which is TiO₂ coated with Sb-doped SnO₂ (product name: FT2000 manufactured by Ishihara Sangyo Kaisha, Ltd.) is further added to the pulp slurry to be used for making paper in the comparative example 3. Except for this, an electrophotographic transfer paper whose glossiness is 51% and basis weight is 64 g/m² is obtained in a similar manner as in the comparative example 3.

### Comparative Example 9

The base material is subject to the smoothing process so that its basis weight is 84 g/m² and glossiness becomes 16%. Except for this, an electrophotographic transfer paper whose basis weight is 100 g/m² is obtained in a similar manner as in the comparative example 1.

The running property and image quality of the electrophotographic transfer paper in the above examples and the comparative examples are evaluated as follows. The results and various characteristic values are shown in Table 1 and 2.

<Evaluation Method>

(1) Basis weight: measured according to JIS P-8124.

(2) Glossiness (75 degrees specular glossiness): measured according to JIS P-8142.

(3) Smoothness: the smoothness of paper whose humidity is adjusted by the sheet seasoning method described below is measured by the method described in J Tappi No. 5.

(4) Thickness and density of paper: measured according to JIS P-8118.

(5) Bending stiffness of paper

A measured value with respect to a test piece with a width of 38 mm is obtained by using a bending stiffness testing machine manufactured by Kumagai Riki Kogyo (model number: 2048-BF) based on ISO 2493 when a bending angle is set to 15° and the span of a stage is set to 10 mm.

(6) Sheet seasoning method

The electrophotographic transfer paper in the examples and the comparative examples is left at rest on a mesh shelf one by one in a seasoning environment, and the humidity is adjusted for 24 hours or more.

(7) Volume resistivity of paper

A R8340 UltraHigh Resistance Meter manufactured by Advantest Corporation is combined with a R12704 Resistivity Chamber so as to measure the volume resistivity using an electrode of 50 mm φ and applied voltage of 100 V based on JIS K-6911.

(8) Running test

The running test is conducted by using an indirect dry type electrophotographic digital color copying machine DocuColor 1250CP manufactured by Fuji Xerox Co., Ltd. At the time of the running test, long grain paper of A4 size (210×297 mm) is used as the electrophotographic transfer paper, and the paper is allowed to run with a long side being a leading end. 100 sheets of each electrophotographic transfer paper obtained in the examples and the comparative examples are allowed to run, a number of sheets causing defective run in the transfer section is checked, and the number is listed in Table 2. Toner is prepared as follows. A resin particle dispersion in which resin particles are dispersed is mixed with a coloring agent dispersion in which a coloring agent is dispersed, the resin particles and the coloring agent are aggregated into a toner particle diameter, and the obtained aggregate is heated to a temperature which is not less than the glass transition point of the resin and fused. The toner prepared by such a method, in which a volume average particle diameter is 6 μm, SF1 is 130 and GSDv is 1.21, is used.

The running test is conducted in three environments of 10° C. and 15% RH, 23° C. and 50% RH, and 30° C. and 85% RH. The running test is conducted for the seasoned paper in the respective environments. Further, when paper which has just been taken out from the package is assumed, the paper is seasoned in the environment of 23° C. and 50% RH, and the running test is conducted in the environments of 10° C. and 15% RH and 30° C. and 85% RH.

(9) Image contrast

An image identifying number N1 (image name: portrait) of ISO/JIS-SCID sample (published by the Japanese Standards Association) is output onto the paper which is seasoned in the environment of 23° C. and 50% RH by a DocuColor 1250CP installed in the environment of 23° C. and 50% RH. The image contrast is evaluated based on the following criterion for evaluation.
A: Excellent because no difference between image portion gloss and blank paper gloss is present.
B: Satisfactory because difference between image portion gloss and blank paper gloss is hardly present.
C: the difference between image portion gloss and blank paper gloss is slightly deteriorated.

D: the difference between image portion gloss and blank paper gloss is remarkably deteriorated.

TABLE 1

| | | Example | | | | Comparative example | | |
|---|---|---|---|---|---|---|---|---|
| | | 1 | 2 | 3 | 4 | 1 | 2 | 3 |
| Basis weight g/m² | | 64 | 64 | 64 | 64 | 64 | 64 | 64 |
| Thickness μm | | 62 | 60 | 58 | 61 | 63 | 75 | 65 |
| Density g/cm³ | | 1.03 | 1.07 | 1.10 | 1.05 | 1.02 | 0.85 | 0.98 |
| Glossiness % | | 54 | 53 | 52 | 57 | 53 | 18 | 52 |
| Physical | Bending stiffness A mN · m | 0.43 | 0.60 | 0.56 | 0.54 | 0.28 | 0.34 | 0.35 |
| properties | Smoothness B sec | 820 | 630 | 720 | 780 | 730 | 530 | 740 |
| at 10° C. and | Volume resistivity C Ωcm | 4.5 × 10¹⁰ | 9.5 × 10¹² | 3.6 × 10¹⁰ | 8.2 × 10¹⁰ | 4.6 × 10¹³ | 9.1 × 10¹³ | 6.5 × 10¹³ |
| 15% RH | A/(logB × logC) | 1.39 × 10⁻² | 1.65 × 10⁻² | 1.86 × 10⁻² | 1.71 × 10⁻² | 7.16 × 10⁻³ | 8.94 × 10⁻³ | 8.83 × 10⁻³ |
| Physical | Bending stiffness A mN · m | 0.40 | 0.55 | 0.52 | 0.49 | 0.23 | 0.32 | 0.31 |
| properties | Smoothness B sec | 750 | 600 | 680 | 700 | 700 | 520 | 710 |
| at 23° C. and | Volume resistivity C Ωcm | 1.5 × 10¹⁰ | 1.8 × 10¹¹ | 1.3 × 10¹⁰ | 1.1 × 10¹⁰ | 9.2 × 10¹¹ | 2.3 × 10¹² | 8.5 × 10¹¹ |
| 50% RH | A/(logB × logC) | 1.37 × 10⁻² | 1.76 × 10⁻² | 1.82 × 10⁻² | 1.72 × 10⁻² | 6.76 × 10⁻³ | 9.53 × 10⁻³ | 9.11 × 10⁻³ |
| Physical | Bending stiffness A mN · m | 0.28 | 0.50 | 0.45 | 0.42 | 0.15 | 0.23 | 0.24 |
| properties | Smoothness B sec | 680 | 540 | 670 | 640 | 660 | 470 | 650 |
| at 30° C. and | Volume resistivity C Ωcm | 8.3 × 10⁸ | 9.5 × 10⁸ | 6.5 × 10⁸ | 3.7 × 10⁹ | 4.5 × 10⁹ | 1.8 × 10⁹ | 5.3 × 10⁹ |
| 85% RH | A/(logB × logC) | 1.11 × 10⁻² | 2.04 × 10⁻² | 1.81 × 10⁻² | 1.56 × 10⁻² | 5.51 × 10⁻³ | 9.30 × 10⁻³ | 8.77 × 10⁻³ |

| | | Comparative example | | | | | |
|---|---|---|---|---|---|---|---|
| | | 4 | 5 | 6 | 7 | 8 | 9 |
| Basis weight g/m² | | 64 | 64 | 64 | 64 | 64 | 100 |
| Thickness μm | | 73 | 54 | 60 | 60 | 65 | 110 |
| Density g/cm³ | | 0.88 | 1.19 | 1.07 | 1.07 | 0.98 | 0.91 |
| Glossiness % | | 25 | 55 | 31 | 62 | 51 | 16 |
| Physical | Bending stiffness A mN · m | 0.36 | 0.22 | 0.27 | 0.30 | 0.34 | 1.23 |
| properties | Smoothness B sec | 400 | 1420 | 370 | 990 | 700 | 740 |
| at 10° C. and | Volume resistivity C Ωcm | 1.5 × 10¹⁴ | 4.8 × 10¹³ | 6.7 × 10¹³ | 2.0 × 10¹⁴ | 9.2 × 10¹⁰ | 6.1 × 10¹³ |
| 15% RH | A/(logB × logC) | 9.76 × 10⁻³ | 5.10 × 10⁻³ | 7.60 × 10⁻³ | 7.00 × 10⁻³ | 1.09 × 10⁻² | 3.11 × 10⁻² |
| Physical | Bending stiffness A mN · m | 0.34 | 0.2 | 0.25 | 0.24 | 0.29 | 1.11 |
| properties | Smoothness B sec | 350 | 1400 | 360 | 970 | 670 | 720 |
| at 23° C. and | Volume resistivity C Ωcm | 3.0 × 10¹² | 5.2 × 10¹¹ | 3.2 × 10¹¹ | 1.0 × 10¹² | 7.5 × 10¹⁰ | 3.4 × 10¹¹ |
| 50% RH | A/(logB × logC) | 1.07 × 10⁻² | 5.43 × 10⁻³ | 8.50 × 10⁻³ | 6.70 × 10⁻³ | 9.44 × 10⁻³ | 3.37 × 10⁻² |
| Physical | Bending stiffness A mN · m | 0.25 | 0.09 | 0.10 | 0.14 | 0.24 | 1.02 |
| properties | Smoothness B sec | 320 | 1350 | 330 | 950 | 640 | 690 |
| at 30° C. and | Volume resistivity C Ωcm | 6.7 × 10⁹ | 1.0 × 10⁹ | 2.0 × 10⁹ | 1.0 × 10⁹ | 3.1 × 10⁸ | 2.4 × 10⁹ |
| 85% RH | A/(logB × logC) | 1.02 × 10⁻² | 3.19 × 10⁻³ | 4.27 × 10⁻³ | 5.22 × 10⁻³ | 1.01 × 10⁻² | 3.83 × 10⁻² |

TABLE 2

| | | Example | | | | Comparative example | | | | | | | | |
|---|---|---|---|---|---|---|---|---|---|---|---|---|---|---|
| | | 1 | 2 | 3 | 4 | 1 | 2 | 3 | 4 | 5 | 6 | 7 | 8 | 9 |
| Running test | Seasoning in the | 0 | 0 | 0 | 0 | 58 | 11 | 17 | 14 | 89 | 36 | 46 | 0 | 0 |
| in the | environment of 10° C. | | | | | | | | | | | | | |
| environment | and 15% RH | | | | | | | | | | | | | |
| of 10° C. and | Seasoning in the | 0 | 0 | 0 | 0 | 68 | 21 | 23 | 0 | 94 | 24 | 63 | 13 | 0 |
| 15% RH | environment of 23° C. | | | | | | | | | | | | | |
| | and 50% RH | | | | | | | | | | | | | |
| Running test | Seasoning in the | 0 | 0 | 0 | 0 | 76 | 9 | 18 | 0 | 96 | 23 | 65 | 24 | 0 |
| in the | environment of 23° C. | | | | | | | | | | | | | |
| environment | and 50% RH | | | | | | | | | | | | | |
| of 23° C. and | | | | | | | | | | | | | | |
| 50% RH | | | | | | | | | | | | | | |
| Running test | Seasoning in the | 0 | 0 | 0 | 0 | 77 | 8 | 21 | 0 | 100 | 94 | 51 | 1 | 0 |
| in the | environment of 30° C. | | | | | | | | | | | | | |
| environment | and 85% RH | | | | | | | | | | | | | |
| of 30° C. and | Seasoning in the | 0 | 0 | 0 | 0 | 76 | 7 | 33 | 0 | 94 | 95 | 68 | 27 | 0 |
| 85% RH | environment of 23° C. | | | | | | | | | | | | | |
| | and 50% RH | | | | | | | | | | | | | |

| | | | | | | | | | | | | | |
|---|---|---|---|---|---|---|---|---|---|---|---|---|---|
| Image contrast | A | A | A | A | A | D | A | C | A | B | A | A | D |

As is clear from Table 1 and Table 2, in the electrophotographic transfer paper of the invention, even if the humidity conditioning state of paper differs in the environments from the low-temperature/low-humidity environment to the high-temperature/high-humidity environment, defective run does not occur in the transfer section, and the image contrast is excellent. Further, even if a lightweight coated paper has small thickness, it has excellent reliability with respect to running property in electrophotographic copying machines and printers in comparison with conventional lightweight coated paper. The electrophotographic transfer paper of the invention has high glossiness and excellent image contrast, and thus it has very high commercial value.

According to the invention, the electrophotographic transfer paper, which is lightweight and whose running property in the transfer section in various environments is improved without lowering the density of formed images, and the image forming method using the paper can be provided.

1. An electrophotographic transfer paper, in which at least one surface of a base material containing pulp fiber has an image receiving surface comprising a coated layer containing pigment and adhesive and a basis weight according to JIS P-8124 is 40 g/m² to 100 g/m²,
wherein when bending stiffness in a cross direction is defined as A mN·m, smoothness is defined as B sec and volume resistivity is defined as C Ωcm, A, B and C satisfy the following equation after seasoning of the electrophotographic transfer paper in each of an environment of 10° C. and 15% RH and an environment of 23° C. and 50% RH:
1.0×10⁻² ≦A/(logB×logC)≦3.0×10⁻².

2. The electrophotographic transfer paper according to claim 1, wherein A, B and C also satisfy the following equation after seasoning of the paper in an environment of 30° C. and 85% RH:
1.0×10⁻²≦A/(logB×logC)≦3.0×10⁻².

3. The electrophotographic transfer paper according to claim 1, wherein a glossiness of the image receiving surface measured based on JIS P-8142 is not less than 30%.

4. The electrophotographic transfer paper according to claim 1, wherein the volume resistivity after seasoning of the paper in the environment of 10° C. and 15% RH is 5.0×10⁸ Ωcm to 1.0×10¹³ Ωcm.

5. The electrophotographic transfer paper according to claim 1, wherein the bending stiffness in the cross direction after seasoning of the paper in an environment of 30° C. and 85% RH is not less than 0.20 mN·m.

6. The electrophotographic transfer paper according to claim 1, wherein at least one of the base material and the coated layer contains an electronically conductive substance.

7. The electrophotographic transfer paper according to claim 1, wherein at least one of the base material and the coated layer contains a cross-linking agent which causes a cross-linking reaction with a hydroxyl group or a carboxyl group.

8. An electrophotographic transfer paper in which at least one surface of a base material containing pulp fiber has an image receiving surface comprising a coated layer containing pigment and adhesive, and a basis weight according to JIS P-8124 is 40 g/m² to 100 g/m²,
wherein at least one of the base material and the coated layer contains a cross-linking agent which causes a cross-linking reaction with a hydroxyl group or a carboxyl group.

9. An image forming method comprising:
forming a latent image on a latent image bearing body;
developing the latent image using electrophotographic developer containing toner;
transferring the developed toner image to a toner image receiving body by means of a transfer member; and
fixing the toner image on the toner image receiving body by application of heat and pressure,
wherein the toner image receiving body is electrophotographic transfer paper in which at least one surface of a base material containing pulp fiber has an image receiving surface comprising a coated layer containing pigment and adhesive and a basis weight according to JIS P-8124 is 40 g/m² to 100 g/m², and when bending stiffness in a cross direction is defined as A mN·m, smoothness is defined as B sec and volume resistivity is defined as C Ωcm, A, B and C satisfy the following equation after seasoning of the electrophotographic transfer paper in each of an environment of 10° C. and 15% RH and an environment of 23° C. and 50% RH:
1.0×10⁻²≦A/(logB×logC)≦3.0×10⁻².

10. The image forming method according to claim 9, wherein A, B and C also satisfy the following equation after seasoning of the electrophotographic transfer paper in an environment of 30° C. and 85% RH:
1.0×10⁻²≦A/(logB×logC)≦3.0×10⁻².

11. The image forming method according to claim 9, wherein a glossiness of the image receiving surface measured based on JIS P-8142 is not less than 30%.

12. The image forming method according to claim 9, wherein the volume resistivity after seasoning of the electrophotographic transfer paper in the environment of 10° C. and 15% RH is 5.0×10⁸ Ωcm to 1.0×10¹³ Ωcm.

13. The image forming method according to claim 9, wherein the bending stiffness in the cross direction after seasoning of the electrophotographic transfer paper in an environment of 30° C. and 85% RH is not less than 0.20 mN·m.

14. The image forming method according to claim 9, wherein at least one of the base material and the coated layer contains an electronically conductive substance.

15. The image forming method according to claim 9, wherein at least one of the base material and the coated layer contains a cross-linking agent which causes a cross-linking reaction with a hydroxyl group or a carboxyl group.

16. An image forming method, comprising:
forming a latent image on a latent image bearing body;
developing the latent image using electrophotographic developer containing toner;
transferring the developed toner image to a toner image receiving body by means of a transfer member; and
fixing the toner image on the toner image receiving body by application of heat and pressure,
wherein the toner image receiving body is electrophotographic transfer paper in which at least one surface of a base material containing pulp fiber has an image receiving surface comprising a coated layer containing pigment and adhesive and a basis weight according to JIS P-8124 is 40 g/m² to 100 g/m², and at least one of the base material and the coated layer contains a cross-linking agent which causes a cross-linking reaction with a hydroxyl group or a carboxyl group.
